(19) United States
(12) Patent Application Publication
(10) Pub. No.: US 2009/0089698 A1
(43) Pub. Date: Apr. 2, 2009

(54) AUTOMATION VISUALIZATION SCHEMA WITH ZOOMING CAPACITY

(76) Inventors: Bruce Gordon Fuller, Edmonton (CA); Brian Alexander Wall, White Rock (CA); Kevin George Gordon, Vancouver (CA); Mark David Hobbs, Hartford, WI (US); Mohamed Salehmohamed, Surrey (CA)

Correspondence Address: ROCKWELL AUTOMATION, INC/SR, 1202 SOUTH SECOND STREET, MAIL STOP E-7F19, MILWAUKEE, WI, 53204, US

(21) Appl. No.: 11/864,473

(22) Filed: Sep. 28, 2007

(51) Int. Cl. G06F 3/14

(52) U.S. Cl. 715/771

(57) ABSTRACT

In order to display automation data, a method is performed including the operations of: receiving an identification of a user, receiving a first view level from a plurality of view levels, wherein each of the plurality of view levels is associated with one of a plurality of hierarchical levels of an enterprise system, selecting a first subset of automation data from the enterprise system based on the user's identification and the first view level, displaying a graphical representation of the first view level, and displaying the first subset of automation data with the graphical representation of the first view level.

### TECHNICAL FIELD

This disclosure is related to the field of factory automation, and in particular, to the display of a subset of factory automation data to a user.

### TECHNICAL BACKGROUND

Industrial processes, such as petroleum refining, water treatment, materials manufacturing, and the like, are increasingly automated and often require constant monitoring of one or more process variables to ensure the process is performing as expected or desired. Such variables may include, for example, pressure, temperature, and flow rate of a liquid or gas being transferred in a conduit. This automation data is often stored in a central database for monitoring and analysis by employees responsible for various portions of the process.

Large enterprises may include multiple industrial processes in operation at a number of different sites. These enterprises may generate extremely large amounts of automation data during their day to day operations. Different employees may need to view different subsets of this automation data. At one point in time, an employee or other user may be concerned about the operation of a single machine within the process, while at other times they may need to monitor the operation of an entire line or process. Also, depending on their job function, they may need to see subsets of the automation data that are normally viewed by people having different job functions. For example, a manager may need to view management data related to a manufacturing line at one point in time, while at another point in time the same manager may need to view engineering data related to the same manufacturing line. Switching between these two differing displays of automation data may be a cumbersome task since different parts of the database will need to be accessed for the two different displays.

### TECHNICAL SUMMARY

In this regard, systems and methods for displaying automation data are provided. An exemplary embodiment of such a method comprises receiving an identification of a user, receiving a first view level from a plurality of view levels, wherein each of the plurality of view levels is associated with one of a plurality of hierarchical levels of an enterprise system, selecting a first subset of automation data from the enterprise system based on the user's identification and the first view level, displaying a graphical representation of the first view level, and displaying the first subset of automation data with the graphical representation of the first view level.

An exemplary embodiment of a system comprises a storage system containing software, and a processing system coupled to the storage system. The processing system is instructed by the software to receive an identification of a user, receive a first view level from a plurality of view levels, wherein each of the plurality of view levels is associated with one of a plurality of hierarchical levels of an enterprise system, select a first subset of automation data from the enterprise system based on the user's identification and the first view level, display a graphical representation of the first view level, and display the first subset of automation data with the graphical representation of the first view level.

An exemplary embodiment of a computer-readable medium of instructions for displaying automation data in a computer system comprises receiving an identification of a user, receiving a first view level from a plurality of view levels, wherein each of the plurality of view levels is associated with one of a plurality of hierarchical levels of an enterprise system, selecting a first subset of automation data from the enterprise system based on the user's identification and the first view level, displaying a graphical representation of the first view level, and displaying the first subset of automation data with the graphical representation of the first view level.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram of an enterprise system according to an embodiment of the invention.

FIG. 2 is a block diagram of a site within an enterprise system according to an embodiment of the invention.

FIG. 3 is a block diagram of a manufacturing line within an enterprise system according to an embodiment of the invention.

FIG. 4 is block diagram of a manufacturing cell within an enterprise system according to an embodiment of the invention.

FIG. 5 is a flowchart of a method for displaying automation data according to an embodiment of the invention.

FIG. 6 is an illustration of example job functions and job levels in an automation environment according to an embodiment of the invention.

FIG. 7 is an illustration of a graphical representation of a view level according to an embodiment of the invention.

FIG. 8 is an illustration of automation data displayed with the graphical representation of a view level from FIG. 7, according to an embodiment of the invention.

FIG. 9 is an illustration of automation data displayed with a graphical representation of a view level different from that of FIG. 8, according to an embodiment of the invention.

FIG. 10 is a block diagram illustrating a computer system in an embodiment of the invention.

### DETAILED DESCRIPTION

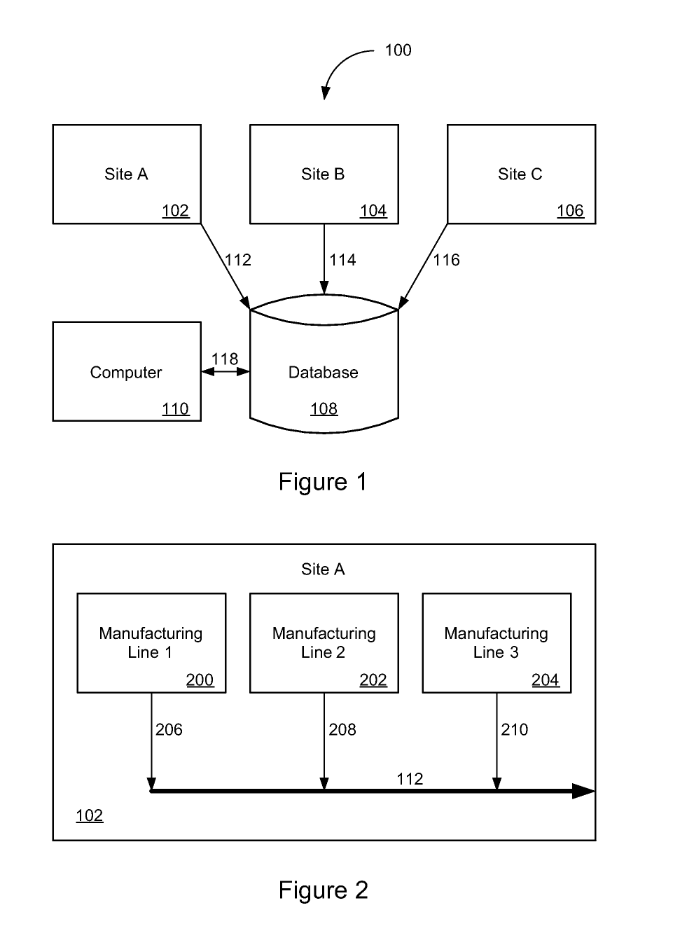

FIG. 1 is a block diagram of an enterprise system according to an embodiment of the invention. In this example embodiment, equipment at three sites send automation data to a central database 108, and this data may be accessed by a computer 110. Site A 102, may include a variety of equipment different from that at Site B 104 and Site C 106. Alternatively, the three sites may include similar equipment distributed among different geographical locations. Those of skill in the art will recognize that any number of sites including any combination of equipment may be present within the scope of the present invention. Automation data 112 from Site A 102 is sent to the database 108 for storage, while automation data 114 from Site B 104, and automation data 116 from Site C 106, are also sent to the database 108 for storage. Those of skill in the art will also recognize that the database 108 shown in this example embodiment may include a plurality of storage devices located at a plurality of geographic locations. In some embodiments, the database 108 may be implemented within the storage system of the computer 110 itself. In this case, the automation data would be transferred from the sites directly to the computer 110 for storage in the database 108.

The automation data 118 from the database 108 may be read, modified, and written by a computer system 110. The computer 110 shown in this example embodiment is representative of any computer 110 at any geographic location (including any of the sites) having access to the database 108 containing automation data. The automation data stored in the database 108 may include data such as details of the operation of equipment used at the various sites, and also may include data such as personnel associated with various pieces of equipment at various times, capacity of the equipment, operation of manufacturing lines, and a very wide variety of other automation data, all within the scope of the present invention. Some example embodiments may continuously update the automation data within the database 108 such that the database 108 contains a real time snapshot of the current status of the equipment at the various sites. This allows users the ability to access the database 108 from a computer 110 and receive real time analysis of the operation of various functions or equipment within a variety of sites. Details of an example structure of automation equipment within these sites are shown in FIGS. 2 through 4 and discussed in detail below.

FIG. 2 is a block diagram of a site within an enterprise system according to an embodiment of the invention. In this example embodiment, Site A 102, from FIG. 1 is shown including three manufacturing lines; Manufacturing Line 1 200, Manufacturing Line 2 202, and Manufacturing Line 3 204. Manufacturing Line 1 200 produces first automation data 206, while Manufacturing Line 2 202 produces second automation data 208, and Manufacturing Line 3 206 produces third automation data 210. This first, second, and third automation data together comprises automation data 112 from Site A 102 for storage in a database 108. While this example embodiment contains three manufacturing lines within Site A, other embodiments may contain any number of manufacturing lines, or other equipment, producing any type of automation data all within the scope of the present invention. FIGS. 1 through 4 are representative examples of a hierarchical structure of an enterprise system generating a quantity of automation data and storing the data in a database 108. Those of skill in the art will recognize that there are a wide variety of ways to structure such systems, and that there are a wide variety of ways to hierarchically describe each system, all within the scope of the present invention. For example, enterprises for the production of a manufactured product will vary from a water treatment plant, or an oil refinery, yet all of these enterprises may generate automation data for storage in a database 108 within the scope of the present invention. Different enterprises and sites will generate different types and quantities of automation and monitoring data. Any type and quantity of automation, process monitoring, process controlling, or other data may be generated by these enterprises within the scope of the present invention.

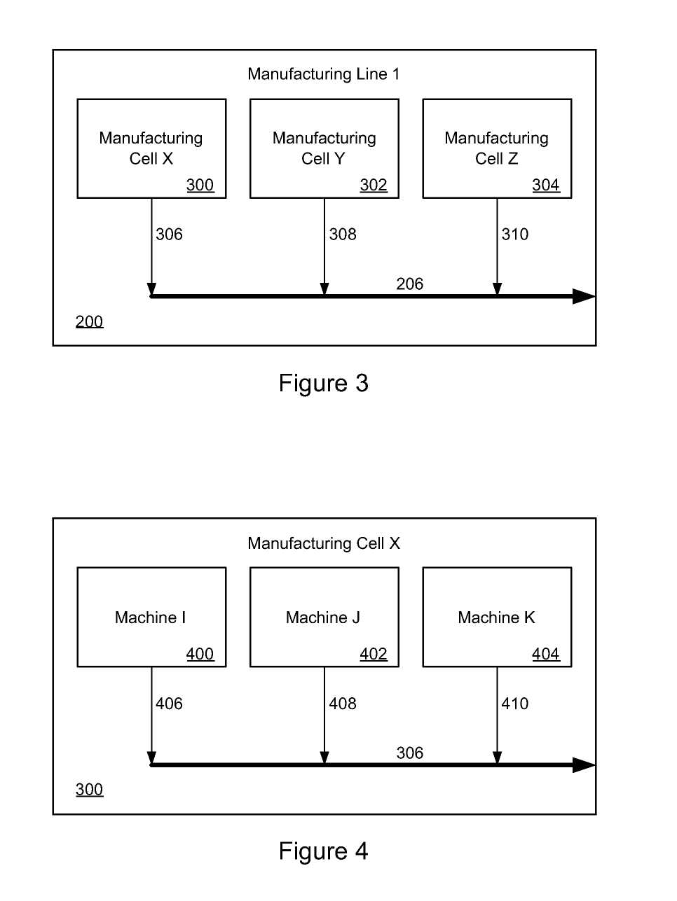

FIG. 3 is a block diagram of a manufacturing line within an automation environment according to an embodiment of the invention. In this example, Manufacturing Line 1 200 from FIG. 2 is shown to contain three manufacturing cells: Manufacturing Cell X 300 producing first automation data 306, Manufacturing Cell Y 302 producing second automation data 308, and Manufacturing Cell Z 304 producing third automation data 310. These three streams of automation data combine to produce the first automation data 206 from Manufacturing Line 1 200 as shown in FIG. 2.

FIG. 4 is block diagram of a manufacturing cell within an automation environment according to an embodiment of the invention. In this example, Manufacturing Cell X 300 from FIG. 3 is shown to contain three machines: Machine I 400 producing first automation data 406, Machine J 402 producing second automation data 408, and Machine K 404 producing third automation data 410. These three streams of automation data combine to produce the first automation data 306 from Manufacturing Cell X 300 as shown in FIG. 3.

The example hierarchical structure of an enterprise system illustrated in FIGS. 1 through 4 is simply one example of a structure of an enterprise that generates a quantity of automation data as part of its normal operation. Other enterprises will most likely have other structures, and differing types and quantities of automation data, all within the scope of the present invention. For example, monitoring requirements of a water treatment plant will differ greatly from the monitoring requirements of an oil refinery or an auto manufacturer. However, virtually all enterprises may be modeled in a hierarchical structure having different levels similar to those illustrated in FIGS. 1 through 4. Other enterprises may have a greater or lesser number of hierarchical levels, and these levels may have differing structures within these levels, all within the scope of the present invention.

Within any enterprise there are a variety of users, each having a different need for data describing the portion of the enterprise for which they have responsibility. For example, a line operator will need to see detailed operation data for the machine that they operate, while a supervisor will need to view less detailed operation data for the manufacturing line or cell for which they are responsible. Likewise, engineers responsible for a manufacturing line will have different data needs than the operators and supervisors of that manufacturing line. Further, managers may be more concerned about the throughput of a manufacturing line than the operating characteristics of the line, while human resources employees will be more interested in the identities of the employees responsible for a line and their salaries, job restrictions, and benefits, than in data concerning the day to day operation of the line. A central database 108 (or a plurality of distributed databases) may contain all of this information necessary to the operation of the enterprise, but if it is difficult for a user to retrieve the subset of this data in which they are particularly interested, the data fails to serve its purpose. By customizing the display of a subset of this automation data, to the job function, job level, and job location of any user, each user will be able to easily analyze the data pertaining to their responsibility.

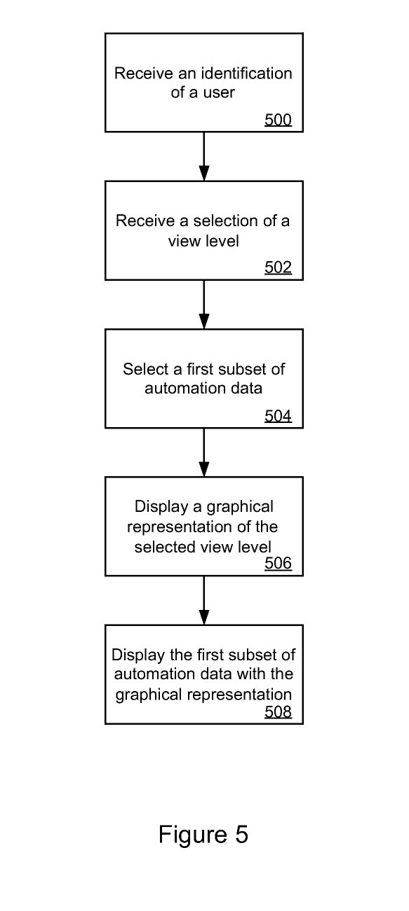

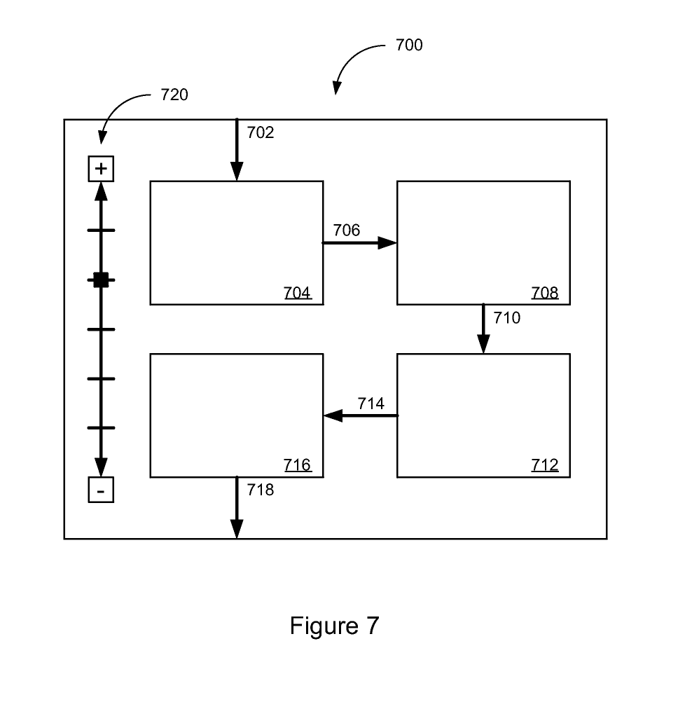

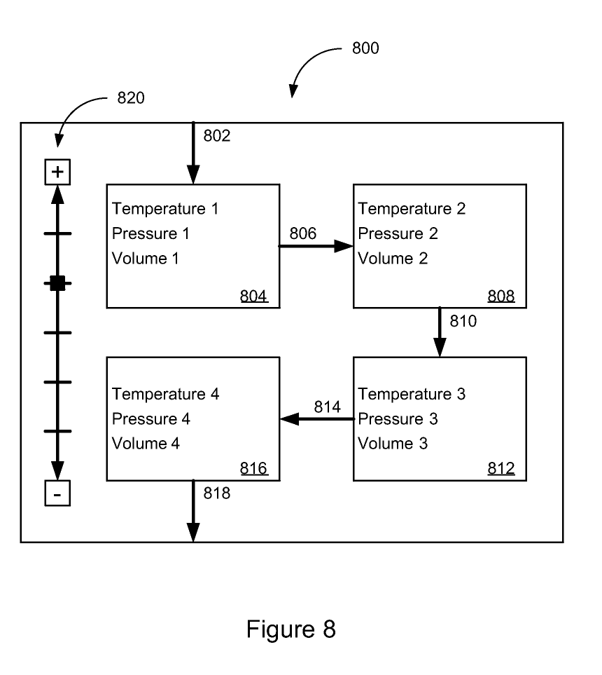

FIG. 5 is a flowchart of a method for displaying automation data according to an embodiment of the invention. In an operation 500, the identification of a user is received. This identification allows the method to select a subset of automation data pertaining to the job responsibility of the user. In an operation 502, a view level is received. This view level corresponds to one of the hierarchical levels of an enterprise, such as those shown in FIGS. 1 through 4. For example, the top view level may include the entire enterprise, such as that shown in FIG. 1, while the lowest view level may be specific to a single machine shown in FIG. 4. Still other view levels may be restricted to a single portion of a single machine. In some embodiments the view level may be equivalent to the job level of the user In an operation 504, a first subset of automation data is selected. This first subset of automation data is selected based on the identity of the user, and the view level received in operation 502. In an operation 506, a graphical representation of the selected view level is displayed. This graphical representation of the selected view level may be a block diagram such as those shown in FIGS. 2 through 4, or any other graphical representation of the enterprise at the selected view level. For example, a view of a manufacturing cell may graphically illustrate the machines contained in that cell. An example graphical representation of a view level is shown in FIG. 7 and described in detail below. In an operation 508, the first subset of automation data is displayed with the graphical representation of the selected view level. For example, in a view of a manufacturing cell containing several machines, automation data such as operating temperature may be shown within or adjacent to the graphical representation of each machine. An example subset of automation data displayed with the graphical representation of the view level is illustrated in FIG. 8 and described in detail below.

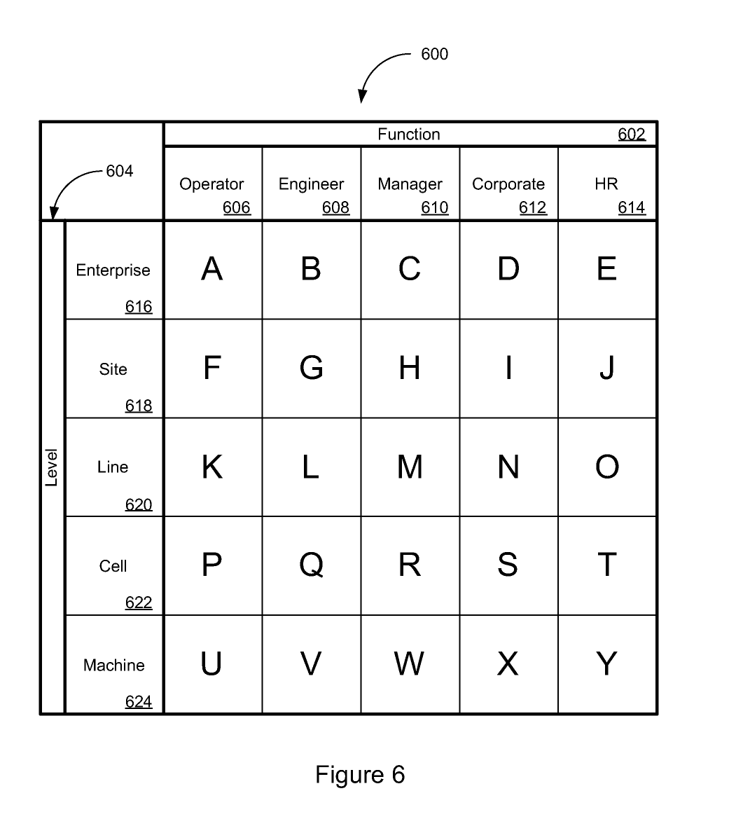

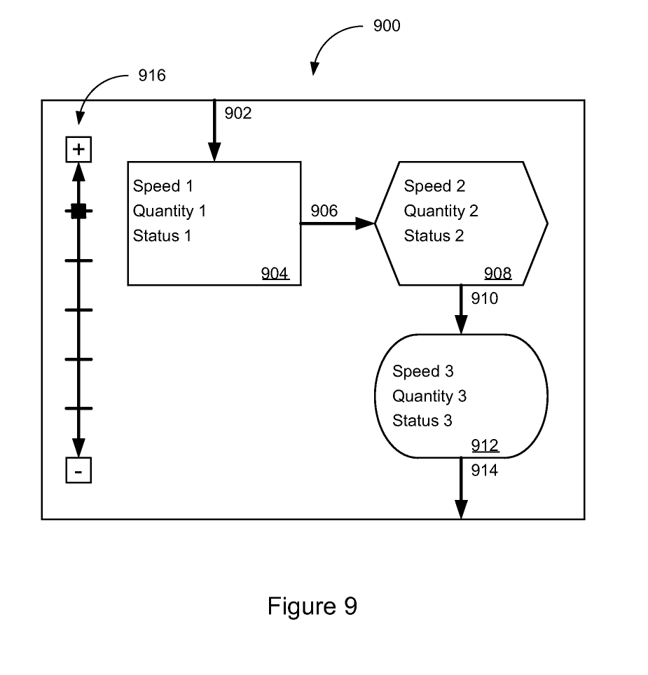

FIG. 6 is an illustration of example job functions and job levels in an automation environment according to an embodiment of the invention. In this example embodiment, an enterprise is graphically illustrated as an array 600, with the enterprise divided into a hierarchy of levels 604, and job functions 602. The enterprise is shown divided into five levels: the top level containing the entire enterprise 616, a site level 618, a manufacturing line level 620, a manufacturing cell level 622, and an individual machine level 624. These example levels correspond to the hierarchical structure of an example enterprise illustrated in FIGS. 1 through 4. The example enterprise also includes five different job functions: operator 606, engineer 608, manager 610, corporate 612, and human resources 614. Other embodiments may include different numbers of functions, and different functions from those shown here, all within the scope of the present invention. This graph 600 illustrates the need for different subsets of automation data (represented here by the letters “A” through “Y”) for different job functions at different levels of hierarchy within the enterprise. For example an operator responsible for a single machine would be most interested in the detailed operation data related to that machine, and represented by the letter U, while an operator responsible for a manufacturing cell would be most interested in the subset of automation data pertaining to that cell, and represented by the letter P. Engineers responsible for a single machine would be interested in the subset of data represented by the letter V, while engineers responsible for an entire manufacturing line would be most interested in the subset of data represented by the letter L. Each user would have the ability to see data related to their job function at each level of hierarchy, and so would be able to control the display to show automation data at each level of hierarchy, but the subset of data selected for display would be related to that user's job function. This zooming between different levels of hierarchy is illustrated in FIGS. 8 and 9, and described in detail below.

Also, some job functions may require the ability to view automation data pertaining to other job functions. For example, managers 610 may also need to see the same automation data as the engineers 608 and operators 606 that report to them. Thus, a site manager would normally be interested in the subset of data represented by letter H, that manager may also need to view engineering data represented by letter G, and operator data represented by letter F. Also, the site manager would need the ability to zoom up and down in hierarchical levels within the operator 606, engineer 608, and manager 610 data, but would not require access to the corporate 612, and human resources 614 data. These other job functions available for use by the user may be referred to as meta job functions. For example, users with the job function of manager may have access to the meta job functions of operator or engineer, but the job functions of corporate or HR would not be meta job functions for the manager. Thus, the system could be configured to restrict which automation data is available to a user, based on the user's job function.

Further, the subset of automation data displayed to a user depends upon that user's job location. For example, operators 606 responsible for different machines 624 would see different subsets of data, each pertaining to their respective machines. Thus, the job location of each user is pertinent in selecting which subset of automation data is displayed to each particular user.

FIG. 7 is an illustration of a graphical representation of a view level according to an embodiment of the invention. In this example display, a graphical representation 700 of a particular view level includes a zoom slider 720, allowing a user to select the hierarchical level of the enterprise (or view level) for display. Those of skill in the art will recognize that there are a wide variety of methods available to allow a user to select a level for display, all within the scope of the present invention. This example graphical representation 700 illustrates an example manufacturing line including four manufacturing cells. A first manufacturing cell 704 receives an input 702 and provides an output 706 coupled to the input of a second manufacturing cell 708. The second manufacturing cell 708 receives an input 706 from the first manufacturing cell 704 and provides an output 710 coupled to the input of a third manufacturing cell 712. The third manufacturing cell 712 receives an input 710 from the second manufacturing cell 708 and provides an output 714 coupled to the input of a fourth manufacturing cell 716. The fourth manufacturing cell 716 received an input 714 from the third manufacturing cell 712 and provides an output 718. The four manufacturing cells are graphically represented by rectangles, and the inputs and outputs of the cells are graphically represented by arrows in FIG. 7. Other embodiments may graphically represent these devices in a wide variety of different ways, all within the scope of the present invention.

FIG. 8 is an illustration of automation data displayed with the graphical representation of a view level from FIG. 7, according to an embodiment of the invention. In this example display 800, a subset of automation data has been combined with the graphical representation of the selected level from FIG. 7. This display 800 includes a zoom slider 820, allowing a user to select the view level of the enterprise for display identical to that of FIG. 7. In this embodiment, automation data has been added to the graphical representations of the four manufacturing cells of FIG. 7. A first manufacturing cell 804 receives an input 802 and provides an output 806 coupled to the input of a second manufacturing cell 808. The second manufacturing cell 808 receives an input 806 from the first manufacturing cell 804 and provides an output 810 coupled to the input of a third manufacturing cell 812. The third manufacturing cell 812 receives an input 810 from the second manufacturing cell 808 and provides an output 814 coupled to the input of a fourth manufacturing cell 816. The fourth manufacturing cell 816 received an input 814 from the third manufacturing cell 812 and provides an output 818. The graphical representation of the first manufacturing cell 804 has been updated to include a first temperature, pressure, and volume. The graphical representation of the second manufacturing cell 808 has been updated to include a second temperature, pressure, and volume. The graphical representation of the third manufacturing cell 812 has been updated to include a third temperature, pressure, and volume. The graphical representation of the fourth manufacturing cell 816 has been updated to include a fourth temperature, pressure, and volume. The arrows representing the inputs and outputs of the four manufacturing cells may also include automation data associated with their particular input or output. For example, the arrows may be color coded to represent the status of their particular input or output, or the arrows may have numeric data associated with them represented a quantity of input or output material. There are a wide variety of methods available for adding a subset of automation data to a graphical representation of a selected level all within the scope of the present invention. For example, automation data may be overlaid upon the graphical representation of the selected level, data may be added to the graphical representation in a separate area of the display, or colors and textures of the graphical representation may be modified to represent the subset of automation data. All possible methods for adding a subset of automation data to a graphical representation of a selected level are included within the scope of the present invention.

FIG. 9 is an illustration of automation data displayed with a graphical representation of a view level different from that of FIG. 8, according to an embodiment of the invention. In this example, a user of the display illustrated in FIG. 8, has selected a different view level via the zoom slider 916. In this example, the user has zoomed in on one of the four manufacturing cells in FIG. 8. This particular example cell contains three machines. A first machine 904 receives an input 902 and provides an output 906 to a second machine 908. The second machine 908 receives an input 906 from the first machine 904 and provides an output to a third machine 912. The third machine 912 receives an input 910 from the second machine 908 and provides an output 914. The graphical representation of the first machine 904 includes a first speed, quantity, and status. The graphical representation of the second machine 908 includes a second speed, quantity, and status. The graphical representation of the third machine 912 includes a second speed, quantity, and status. The arrows representing the inputs and outputs of the three machines may also include automation data displayed in any of a wide variety of ways all within the scope of the present invention.

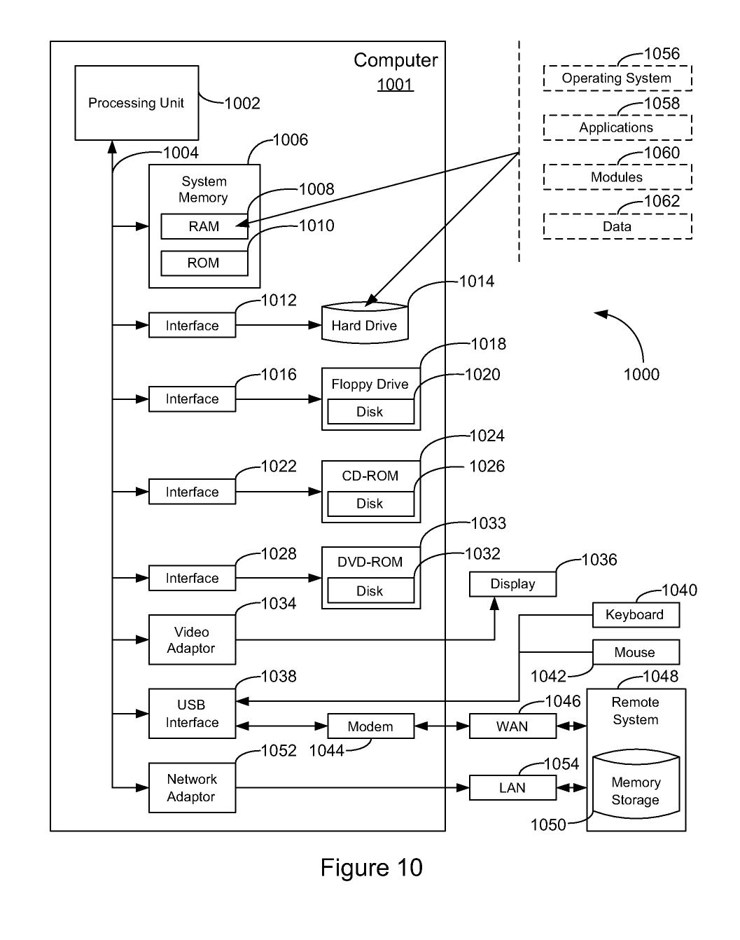

FIG. 10 is a block diagram illustrating a computer system in an embodiment of the invention. Computer system 1000 includes a computer 1001 which includes a processing unit 1002, a system memory 1006, and a system bus 1004 that couples various system components including the system memory 1006 to the processing unit 1002. The processing unit may be any of a wide variety of processors or logic circuits, including the Intel X86 series, Pentium, Itanium, and other devices from a wide variety of vendors. The processing unit 1002 may include a single processor, a dual-core processor, a quad-core processor or any other configuration of processors, all within the scope of the present invention. Computer 1001 could be comprised of a programmed general-purpose computer, although those skilled in the art will appreciate that programmable or special purpose circuitry and equipment may be used. Computer system 1000 may be distributed among multiple devices that together comprise elements 1002-1062.

Those of skill in the art will recognize that there are a wide variety of system bus 1004 architectures, such as PCI, VESA, Microchannel, ISA, and EISA, available for use within the computer 1001, and multiple system buses may be used within the computer 1001, all within the scope of the present invention. The system memory 1006 includes random access memory (RAM) 1008, and read only memory (ROM) 1010. The system ROM 1010 may include a basic input/output system (BIOS), which contains low-level routines used in transferring data between different elements within the computer, particularly during start-up of the computer. The system memory 1006 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the system memory 1006 may incorporate electronic, magnetic, optical, and/or other types of storage media. Note that the system memory 1006 can have a distributed architecture, where various components are situated remote from one another, but can be accessed by the processing unit 1002.

The processing unit 1002 receives software instructions from the system memory 1006 or other storage elements and executes these instructions directing the processing unit 1002 to operate in a method as described herein. These software instructions may include an operating system 1056, applications 1058, modules 1060, utilities, drivers, networking software, and data 1062. Software may comprise firmware, or some other form of machine-readable processing instructions.

The computer 1001 also includes a hard drive 1014 coupled to the system bus 1004 through a hard drive interface 1012, a floppy drive 1018 containing a floppy disk 1020 coupled to the system bus 1004 through a floppy drive interface 1016, a CD-ROM drive 1024 containing a CD-ROM disk 1026 coupled to the system bus 1004 through a CD-ROM drive interface 1022, and a DVD-ROM drive 1033 containing a DVD-ROM disk 1032 coupled to the system bus 1004 through a DVD-ROM drive interface 1028. Those of skill in the art will recognize that there are a wide variety of other storage elements, such as flash memory cards and tape drives, available for inclusion in a computer 1001, which may be coupled to the system bus 1004 through a wide variety of interfaces, all within the scope of the present invention. Also, these storage elements may be distributed among multiple devices, as shown here, and also may situated remote from each other, but can be accessed by the processing unit 1002.

The computer 1001 also includes a video adaptor 1034 configured to drive a display 1036, and a universal serial bus (USB) interface 1038 configured to receive user inputs through a keyboard 1040 and a mouse 1042. Other user interfaces could comprise a voice recognition interface, microphone and speakers, graphical display, touch screen, game pad, scanner, printer, or some other type of user device. These user interfaces may be distributed among multiple user devices. The USB interface 1038 is also configured to interface with a modem 1044 allowing communication with a remote system 1048 through a wide area network (WAN) 1046, such as the internet.

The computer 1001 further includes a network adaptor 1052 configured to communicate to a remote system 1048 through a local area network (LAN) 1045. Those of skill in the art will recognize that there are a wide variety of network adaptors 1052 and network configurations available to allow communication with remote systems 1048 all within the scope of the present invention. For example, networks may include Ethernet connections or wireless connections. Networks may be local to a single office or site, or may be as broad and inclusive as the internet or usenet. Remote systems 1048 may include memory storage 1050 in a very wide variety of configurations, all within the scope of the present invention.

In this example embodiment of the present invention, the software instructions may be configured to cause the processing unit 1002 to execute the operations of the methods illustrated in FIGS. 1 through 9. The system memory 1006 and storage devices may be configured to store the user identity, graphical representation of selected levels, and subsets of the automation data. In such a configuration, the computer 1001 is acting as the computer 110 shown in FIG. 1, and the memory storage 1050 within the remote system 1048 is operating as the database 108 shown in FIG. 1.

One should note that the flowcharts included herein show the architecture, functionality, and/or operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions (such as depicted in the flowcharts), can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiments without departing substantially from the spirit and principles of the disclosure. All such modifications and variations are intended to be included herein within the scope of this disclosure.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
receiving an identification of a user;
receiving a first view level from a plurality of view levels, wherein each of the plurality of view levels is associated with one of a plurality of hierarchical levels of an enterprise system;
selecting a first subset of automation data from the enterprise system based on the user's identification and the first view level;
displaying a graphical representation of the first view level; and
displaying the first subset of automation data with the graphical representation of the first view level.

2. The method of claim 1,
wherein the identification of the user includes:
a job function of the user,
a job level of the user, and
a job location of the user.

3. The method of claim 2, further comprising:
selecting a view level based on the user's job level.

4. The method of claim 2, further comprising:
determining a set of meta job functions for the user, based on the user's job function.

5. The method of claim 4, further comprising:
allowing the user to select a meta job function from the set of meta job functions;
selecting a second subset of automation data from the enterprise system based on the user's identification, the first view level, and the meta job function;
displaying a graphical representation of the first view level; and
displaying the second subset of automation data with the graphical representation of the first view level.

6. The method of claim 1, further comprising:
allowing the user to select a second view level;
selecting a second subset of automation data from the enterprise system based on the user's identification, and the second view level;
displaying a graphical representation of the second view level; and
displaying the second subset of automation data with the graphical representation of the second view level.

7. The method of claim 1,
wherein displaying the first subset of automation data includes overlaying the first subset of automation data on the graphical representation of the first view level.

8. The method of claim 1,
wherein displaying the first subset of automation data includes modifying the graphical representation of the first view level.

9. The method of claim 1,
wherein displaying the first subset of automation data includes adding the automation data to the graphical representation of the first view level.

10. A computer system, comprising:
a storage system containing software; and
a processing system coupled to the storage system;
wherein the processing system is instructed by the software to:
receive an identification of a user;
receive a first view level from a plurality of view levels, wherein each of the plurality of view levels is associated with one of a plurality of hierarchical levels of an enterprise system;
select a first subset of automation data from the enterprise system based on the user's identification and the first view level;
display a graphical representation of the first view level; and
display the first subset of automation data with the graphical representation of the first view level.

11. The computer system of claim 10, further comprising:
a database containing automation data.

12. The computer system of claim 10,
wherein the identification of the user includes:
a job function of the user,
a job level of the user, and
a job location of the user.

13. The computer system of claim 12,
wherein the processing unit is also instructed by the software to:
select a view level based on the user's job level.

14. The computer system of claim 12,
wherein the processing unit is also instructed by the software to:
determine a set of meta job functions for the user, based on the user's job function.

15. The computer system of claim 14,
wherein the processing unit is also instructed by the software to:
allow the user to select a meta job function from the set of meta job functions;
select a second subset of automation data from the enterprise system based on the user's identification, the first view level, and the meta job function;
display a graphical representation of the first view level; and
display the second subset of automation data with the graphical representation of the first view level.

16. The computer system of claim 10,
wherein the processing unit is also instructed by the software to:
allow the user to select a second view level;
select a second subset of automation data from the enterprise system based on the user's identification, and the second view level;
display a graphical representation of the second view level; and
display the second subset of automation data with the graphical representation of the second view level.

17. The computer system of claim 10,
wherein the processing unit is also instructed by the software to:
overlay the first subset of automation data on the graphical representation of the first view level.

18. A computer-readable medium of instructions for displaying automation data in a computer system, the instructions comprising:
receiving an identification of a user;
receiving a first view level from a plurality of view levels, wherein each of the plurality of view levels is associated with one of a plurality of hierarchical levels of an enterprise system;
selecting a first subset of automation data from the enterprise system based on the user's identification and the first view level;
displaying a graphical representation of the first view level; and
displaying the first subset of automation data with the graphical representation of the first view level.

19. The computer-readable medium of instructions of claim 18, further comprising:
allowing the user to select a second view level;
selecting a second subset of automation data from the enterprise system based on the user's identification, and the second view level;
displaying a graphical representation of the second view level; and
displaying the second subset of automation data with the graphical representation of the second view level.

20. The computer-readable medium of instructions of claims 18,
wherein displaying the first subset of automation data includes overlaying the first subset of automation data on the graphical representation of the first view level.
